(19) United States
(12) Patent Application Publication
(10) Pub. No.: US 2026/0264942 A1
(43) Pub. Date: Sep. 10, 2026

(54) CLOSURES AND MOLD ASSEMBLIES FOR MAKING CLOSURES

(71) Applicant: Husky Injection Molding Systems Ltd., Bolton (CA)

(72) Inventor: Tobias Naumann, Merzig (DE)

(73) Assignee: Husky Injection Molding Systems Ltd., Bolton (CA)

(21) Appl. No.: 19/168,269

(22) PCT Filed: Mar. 24, 2023
(86) PCT No.: PCT/CA2023/050403

§ 371 Date: Sep. 23, 2025

(51) Int. Cl. B65D 41/34; B29C 33/30; B29C 43/36; B29C 45/33; B29L 31/56; B65D 55/16

(52) U.S. Cl. CPC B65D 41/3447; B29C 33/306; B29C 43/36; B29C 45/33; B65D 55/16; B29C 2043/3665; B29L 2031/56; B65D 2211/00

(57) ABSTRACT

A mold assembly (100) for molding tethered and non-tethered closures (106, 206), which includes a core (112, 114) with recesses (101a, 101b, 101c) in its circumferential surface (114a) that describe cams (107a, 107b, 107c, 207a, 207b, 207c) for engaging a flange of a neck of a container to which the closure is to be installed. The mold assembly has a first configuration, in which the core and a first set of slides (122A, 122B) together describe a closure (106) having a completely removable tamper evidence band (107), and a second configuration, in which the same core and a second set of slides (222A, 222B) together describe a closure (206) with a tamper evidence band (207) that is retained by tethers (209). The cams (107a, 107b, 107c, 207a, 207b, 207c) of both closures (106, 206) are at different axial locations for accommodating the tethers in the second configuration.

### FIELD OF THE INVENTION

This invention relates generally to closures, molding apparatus and associated methods. More specifically, although not exclusively, this invention relates to molded closures for sealingly closing beverage containers, and to slides, mold stacks, mold assemblies, molds and molding systems for molding such closures, and to associated methods.

### BACKGROUND OF THE INVENTION

Containers, such as bottles, are generally provided with closures, such as caps, to fluidly seal the container. Plastic beverage closures normally include four main functional elements: a tubular body, securing feature(s), sealing feature(s) and tamper evidence feature(s). The body typically includes a top wall, usually circular, with an annular side wall depending from the top wall. The side wall is typically in the form of a cylindrical skirt extending perpendicularly from the periphery of the top wall. The securing feature usually includes either a screw thread, or a snap on feature, both of which are known in the art. The securing feature is normally formed integrally with the side wall on the inner surface thereof and adjacent to the container opening, for example the neck of a bottle. Several different sealing features are known in the art which can be applied in isolation or in various combinations.

Molding is a process by virtue of which a molded article can be formed from molding material, such as a plastics material, by using a molding system, such as an injection molding system or a compression molding system. Various molded articles can be formed by using such molding processes including, for example, closures as described above. A typical closure mold includes a plurality of mold stacks each describing a closure. A typical mold stack for molding such closures includes a core describing inner surfaces of the closure, a cavity describing outer surfaces of the closure and slides describing outer surfaces at the open end of the closure. The slides are split and separable to enable delicate, radial features to be molded and ejected without being damaged.

In recent years, it has become desirable to tether the closure to the container. Tethering of a closure to its respective container often includes certain mechanisms which allow an attachment of the closure to a tamper-evidence (TE band) band at an open end of the container. Such mechanisms generally allow severing of frangible links between the closure and the TE band during opening of the closure, yet allow the closure to stay connected to the TE band and hence the container when in the open configuration. The typical mechanism also allows the closure to be actuated between closed and open configurations.

Not only is tethering a matter of convenience, but it is also becoming a legal requirement in certain jurisdictions. However, incorporating tether features adds cost and complexity so in some cases manufacturers prefer to continue to offer non-tethered closures.

### SUMMARY OF THE INVENTION

The present invention seeks to provide, inter alia, a means by which both tethered and non-tethered closures can be made using a common mold assembly. This invention is directed, in particular but not exclusively, to closures, and to slides, mold stacks, mold assemblies, molding systems and associated methods. The mold assembly may comprise a plurality of slides, e.g., for describing respective outer closure portions. The mold assembly may have a first configuration, which may be a non-tethered configuration. The mold assembly may have a second configuration, which may be a tethered configuration. In the first configuration, a first combination of the slides may together describe part of a closure having a tamper evidence band frangibly connected to and completely separable from a lid of the closure. In the second configuration, a second combination of the slides may together describe part of a closure having a tamper evidence band, which is frangibly connected to and partially separable from a lid of the closure, and one or more tethers retaining the tamper evidence band to the closure lid.

According to a first broad aspect of the present invention, there is provided a mold assembly for molding tethered and non-tethered closures, the assembly comprising a plurality of slides describing respective outer closure portions, wherein the assembly comprises a first, non-tethered configuration, in which a first combination of the slides together describe part of a closure having a tamper evidence band, which is frangibly connected to and completely separable from a lid of the closure; and a second, tethered configuration, in which a second combination of the slides together describe part of a closure having a tamper evidence band, which is frangibly connected to and partially separable from a lid of the closure, and one or more tethers retaining the tamper evidence band to the closure lid.

The provision of a mold assembly that can be reconfigured between non-tethered and tethered configurations by changing the slides enables the manufacture of both variants without the purchase of multiple molds.

The mold assembly may comprise a core, e.g., for describing an inner portion of a closure. The core may include a first recess portion, e.g., in its circumferential surface. The core may include a second recess portion, e.g., in its circumferential surface. The first recess portion may describe a first radial projecting portion of a tamper evidence band of the closure, e.g., for engaging a flange of a neck of a container to which the closure is to be installed. The second recess portion may describe a second radial projecting portion of a tamper evidence band of the closure, e.g., for engaging the flange of the neck of a container to which the closure is to be installed. The first and second recess portions of the core may be at different axial locations for accommodating the one or more tethers in the second configuration.

According to another broad aspect of the invention, there is provided a mold assembly for molding tethered and non-tethered closures, the assembly comprising: a core describing an inner portion of a closure, the core including first and second recess portions in its circumferential surface which describe respective first and second radial projecting portions of a tamper evidence band of the closure for engaging a flange of a neck of a container to which the closure is to be installed; and a plurality of slides describing respective outer closure portions; the assembly comprising: a first, non-tethered configuration, in which the core and a first combination of the slides together describe at least part of a closure having a tamper evidence band, which is frangibly connected to and completely separable from a lid of the closure; and a second, tethered configuration, in which the core and a second combination of the slides together describe at least part of a closure having a tamper evidence band, which is frangibly connected to and partially separable from a lid of the closure, and one or more tethers retaining the tamper evidence band to the closure lid; wherein the first and second recess portions of the core are at different axial locations for accommodating the one or more tethers in the second configuration.

The inventors have established that the skewed positioning of the tamper evident band retaining projections, which is required for some tethered closure configurations, is also suitable for non-tethered closures. In fact, the inventors have found that such skewed positioning can be advantageous. Thus, both closure designs can be made using the same core design, thereby further reducing the cost of the mold assembly.

The core may comprise an end portion. The end portion may describe at least part of an inner surface of a top wall of the closure or lid. The second recess portion may be spaced further from the end portion than the first recess portion.

The slides may describe a first line of weakness. The first line of weakness may be between or located between the tamper evidence band and the closure lid, e.g., in both the first and second configurations. The first line of weakness may be at a first axial position, e.g., in both the first and second configurations. The slides may describe at least part of the or each tether between the first line of weakness and the second recess portion in the second configuration.

The core may comprise a third recess portion in its circumferential surface. The third recess portion may describe a third radial projecting portion of a tamper evidence band of the closure, e.g., for engaging a flange of a neck of a container to which the closure is to be installed. The third recess portion may be spaced further from the end portion than the first and/or second recess portions.

The slides may describe a tongue in the second configuration. The tongue may depend from the closure lid and/or be circumferentially aligned with the third recess portion. The tether(s) may comprise a pair of tethers. The tongue may depend from the closure lid between the pair of tethers.

The plurality of slides comprises three slides. The plurality of slides may comprise first, second and third slides. The first combination of slides may comprise the first and second slides. The second combination of slides may comprise the first and third slides. The first and second slides may have substantially the same shape and configuration, e.g., such that the outer surface of the closure described by the slides in the first configuration is substantially symmetrical. The one or more tethers may be described by the third slide, e.g., only the third slide, in the second configuration.

Alternatively, the plurality of slides comprises four slides. The plurality of slides may comprise first, second, third and fourth slides. The first combination of slides may comprise the first and second slides. The second combination of slides may comprise the third and fourth slides. The one or more tethers may be described in part by each of the third and fourth slides.

The first and second recess portions may comprise separate recesses, e.g., separate first and second recesses respectively. At least one or each recess may describe a respective cam. At least one or each cam may project radially, e.g., radially inwardly, from the tamper evidence band. At least one or each of the recesses may be sloped, e.g., on an opposite side to the closure lid. The slope or sloped portion of the recess may describe a lead-in ramp on the cam described thereby.

The core may comprise an inner core and/or an outer core. The outer core may comprise the recess portions. The core or outer core may comprise securing features, e.g., a circumferential groove for describing a snap fit engagement feature in the closure lid or one or more helical recesses for describing one or more threads in the closure lid. The outer core may comprise the end portion or part of the end portion. The end portion of the outer core may describe an outer part, e.g., an annular outer part, of the inner surface of the top wall of the closure. The inner core may comprise the end portion or part of the end portion. The end portion of the inner core may describe an inner part, e.g., a circular inner part, of the inner surface of the top wall of the closure. One or more sealing features, e.g., a plug seal or an annular and/or cylindrical seal or sealing wall or sealing plug, may be described between the inner and outer cores.

The mold assembly may comprise a cavity or cavity insert, which may describe at least part of an outer surface of the closure. The cavity or cavity insert may describe part of an outer surface of the top wall. The cavity or cavity insert may describe an outer surface of a side wall of the closure lid. The cavity or cavity insert may describe together with the slides the outer surfaces of the closure. The mold assembly may comprise a gate insert or gate pad, which may describe part of an outer surface of the top wall. The gate insert or gate pad may describe an inner and/or circular outer surface or surface portion of the top wall. The cavity or cavity insert may describe an annular outer surface or surface portion of the top wall, which may surround the inner and/or circular outer surface or surface portion of the top wall described by the gate insert or gate pad. The cavity or cavity insert, or gate insert, or gate pad may comprise or describe a nozzle receiving receptacle. The cavity or cavity insert, or gate insert, or gate pad may comprise or describe a gate, which may extend between the cavity and the nozzle receiving receptacle.

The mold assembly may comprise a stripper ring, which may surround the core or outer core. The stripper ring may comprise an abutment, e.g., an annular abutment, which may be configured to urge, in use, the closure from or off the core or outer core. The abutment or annular abutment may surround the core or outer core. The mold assembly may comprise any one or more features described below in connection with the drawings, either in isolation or in any suitable combination, whether or not it is described together with other features.

The mold assembly may comprise a mold stack. The mold stack may include the slides and/or the core and/or the cavity or cavity insert and/or the gate insert or gate pad and/or the stripper ring. The mold stack may have a molding configuration, e.g., in which the mold stack describes a cavity, for making the closure. The mold stack may have a demolding configuration, e.g., in which the slides are separated from the core and/or from one another and/or from the cavity, for removing the closure therefrom.

According to another broad aspect of the invention, there is provided a mold stack comprising the aforementioned slides. The mold stack may include the aforementioned core and/or the aforementioned cavity or cavity insert and/or the aforementioned gate insert or gate pad and/or the aforementioned stripper ring.

According to another broad aspect of the invention, there is provided a molding system including the aforementioned mold. The molding system may comprise a molding machine, for example an injection or compression molding machine. The molding machine may comprise an injection unit, e.g., for injecting molten plastic material into the mold assembly or a cavity thereof. The molding machine may comprise a clamp unit, e.g., for holding and/or retaining the mold stack in a molding configuration during and/or after material is introduced or injected therein. The molding system may comprise an ejection system, which may be operable to actuate the mold stack from the molding configuration to a demolding configuration.

According to another broad aspect of the invention, there is provided a method of reconfiguring a mold assembly for making closures. The method may relate to reconfiguring the mold assembly between first and second configurations. The first configuration may be for making non-tethered closures. The second configuration may be for making tethered closures. The method may comprise replacing one or more slides. The method may comprise replacing the slide(s) without replacing a core of the mold assembly. The non-tethered closure and the tethered closure may both have a tamper evidence band with radial projecting portions at different axial locations.

According to another broad aspect of the invention, there is provided a method of reconfiguring a mold assembly for making closures between a first configuration for making non-tethered closures and a second configuration for making tethered closures, the method comprising replacing one or more slides without replacing a core of the mold assembly, such that the non-tethered closure and the tethered closure both have a tamper evidence band with radial projecting portions at different axial locations.

The method may comprise replacing only one slide, e.g., such that the tethers are confined to one side of the tethered closure. Alternatively, the method may comprise replacing multiple slides, e.g., both or all of the slides.

Other features of the method will be apparent to the skilled person in light of the aforementioned features of the mold assembly.

According to another broad aspect of the invention, there is provided a closure comprising a lid and a tamper evidence band frangibly connected to and completely separable from the lid, wherein the tamper evidence band comprises first and second radial projecting portions at different axial locations for engaging a flange of a neck of a container to which the closure is to be installed.

Another aspect of the invention provides a computer program element comprising and/or describing and/or defining a three-dimensional design for use with a simulation means or a three-dimensional additive or subtractive manufacturing means or device, e.g. a three-dimensional printer or CNC machine, the three-dimensional design comprising a closure, mold assembly, mold, slides, core or any one or more other mold components described above.

For the avoidance of doubt, any of the features described herein apply equally to any aspect of the invention. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

For the avoidance of doubt, the terms “may”, “and/or”, “e.g.,”, “for example” and any similar term as used herein should be interpreted as non-limiting such that any feature so described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 shows a section view through a portion of a mold assembly and of a mold stack thereof, which is configured to mold a closure without tethers;

FIG. 2 shows an enlarged view of the molding surfaces and split lines of the stack components of FIG. 1;

FIG. 3A shows the mold assembly of FIG. 1 in a mold-closed configuration for molding of a molded article therein;

FIG. 3B shows a first stage in an ejection of the molded article from the mold assembly of FIG. 1, wherein the mold assembly has been arranged into a mold-open configuration;

FIG. 3C shows a second stage in the ejection of the molded article from the mold assembly of FIG. 1, wherein the first stack portion has been re-arranged to move a first slide and a second slide thereof into a first slide clearance position and a second slide clearance position, respectively, with movement of a stripper sleeve towards a stripping position;

FIG. 3D shows a third stage in the ejection of the molded article from the mold assembly of FIG. 1, wherein the first stack portion has been further re-arranged to move an outer core relative to an inner core thereof to provide for release of part of the molded article from therebetween;

FIG. 3E shows a final stage in the ejection of the molded article from the mold assembly of FIG. 1, wherein the first stack portion has been further re-arranged to move the stripper sleeve into its stripping position and in so doing strip the molded article from the outer core;

FIG. 4 shows a perspective view of a closure molded with the mold of FIG. 1;

FIG. 5 shows the inner cams of the closure of FIG. 4;

FIG. 6 shows an enlarged view of the molding surfaces and split lines of another configuration of stack components for use in the mold of FIG. 1, which are configured to make a closure with tethers;

FIG. 7 shows a perspective view of a closure molded with the mold stack configuration of FIG. 6; and

FIG. 8 shows the inner cams of the closure of FIG. 7.

### DETAILED DESCRIPTION OF THE INVENTION

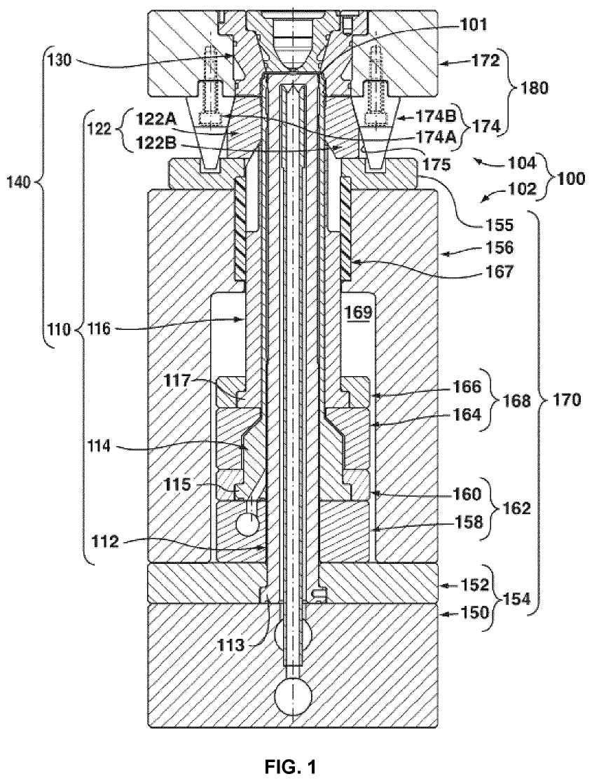

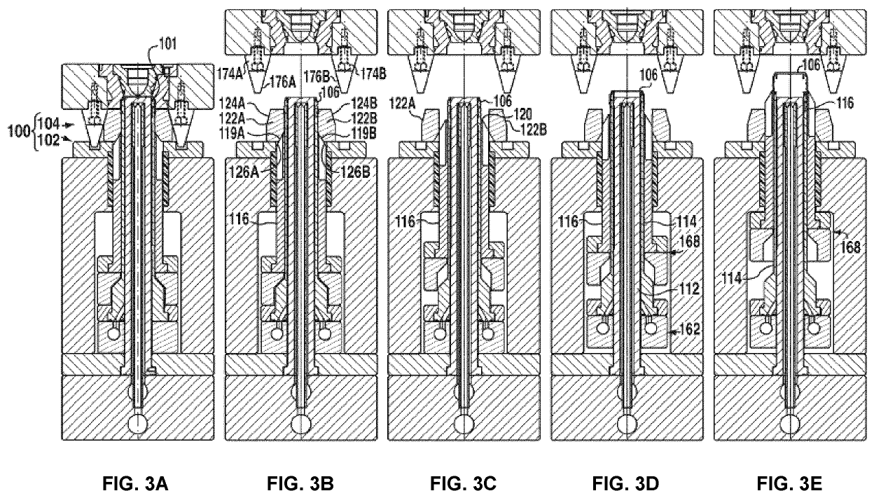

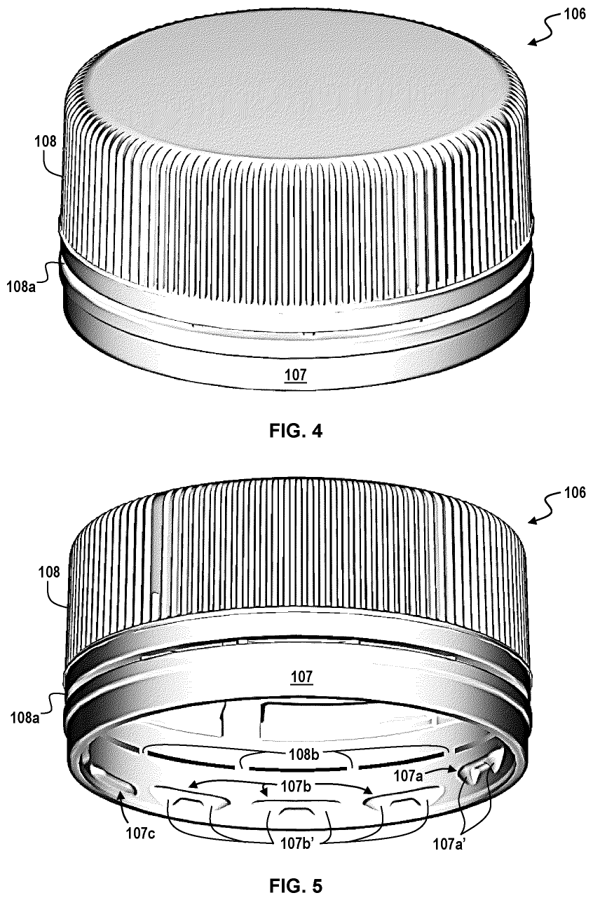

With reference to FIGS. 1 to 3E, the mold assembly 100 includes a first mold half 102 and a second mold half 104 that are associated, in use, with platens of an injection molding machine (not shown) for a repositioning thereof between a mold-closed configuration, as shown, and a mold-open configuration (FIG. 3B). In the mold-closed configuration a molding cavity 101 is defined in a mold stack 140 that is associated with the mold assembly 100 within which a molded article 106 (FIGS. 4 and 5), such as, for example, a closure of a type for capping a bottle, is moldable. In the mold-open configuration a first stack portion 110 and a second stack portion 130 of the mold stack 140, that are associated with the first mold half 102 and the second mold half 104, respectively, are separated to open the molding cavity 101 for a subsequent release of the closure 106 therefrom.

The first mold half 102 broadly includes a first mold shoe 170 with which the first stack portion 110 is associated. More particularly, the first mold shoe 170 provides for coupling, in use, the first stack portion 110 to one of the platens (not shown) of the injection molding machine (not shown), as well as for repositioning members of the first stack portion 110 between a molding configuration and an ejection configuration.

The first stack portion 110 broadly includes an inner core 112, an outer core 114, and a slide pair 122 with which to define an inner portion and an encapsulated portion of the molding cavity 101. The first stack portion 110 also includes a stripper sleeve 116 with which to open the slide pair 122 and to strip the closure 106 from the outer core 114.

The inner core 112 has a cylindrical body around which a tubular body of the outer core 114 is slidably arranged to accommodate relative movement thereof, along the mold-stroke axis, whereby a part of the closure 106 is releasable from therebetween. The inner portion of the molding cavity 101 (FIG. 1) includes an outer surface at a first end of the tubular body, a top face of the cylindrical body, and confronting surfaces therebetween.

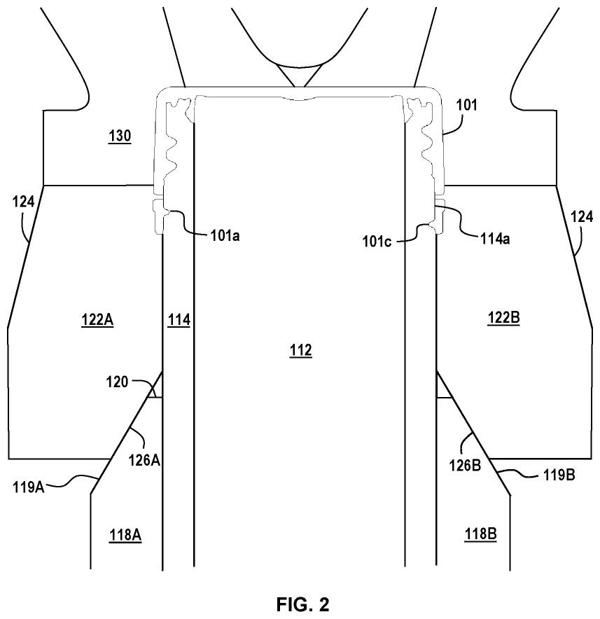

FIG. 2 shows an enlarged view of stack components of the mold assembly 100 in a first, non-tethered configuration. The outer core 114 includes a plurality of recesses 101a, 101c (only two of which are shown) in its circumferential surface 114a. These recesses 101a, 101c describe respective projections or cams 107a, 107b, 107c of a tamper evidence band 107 of the closure 106, shown in FIGS. 4 and 5, for engaging a flange of a neck of a container (not shown) to which the closure 106 is to be installed. The tamper evidence band 107 is frangibly connected to a lid 108 of the closure 106 along a line of weakness 108a. In this configuration of the mold assembly 100, the tamper evidence band 107 is completely separable from the lid 108 when the frangible connection is severed.

The skilled person will appreciate that the frangible connection may be achieved by any known arrangement. In the arrangement shown in FIGS. 4 and 5, the frangible connection includes thin bridges 108b joining the tamper evidence band 107 to the lid 108, which are designed to sever when the lid 108 is unscrewed from the container neck, whilst the tamper evidence band 107 is retained thereon by virtue of the cams 107a, 107b, 107c engaging a flange on the neck (not shown).

In this example, the closure 106 includes three sets of cams 107a, 107b, 107c, each at different axial locations, that is to say at differing distances from the lid 108 of the closure 106. More specifically, a first group of cams 107a is located immediately below the line of weakness 108a, while a second group of cams 107b is located slightly further from the line of weakness 108a and a third group of cams 107c is located further still from the line of weakness 108a. Each cam 107a, 107b of the first and second groups includes a pair of lead-in ramps 107a′ 107b′ at each of its circumferential ends, providing an inverted U-shape, while the third group of cams 107c do not.

This, skewing of the cams 107a, 107b, 107c results in some deformation of the tamper evidence band 107 as the lid 108 of the closure 106 is removed from the container neck (not shown). The inventors have found that this deformation causes the first set of cams 107a to be drawn into the space beneath the tamper evidence flange of the container neck, which can, in some cases, mitigate the effect of a tamper evidence band 107 having a slightly larger (e.g. out of tolerance) diameter, for example due to manufacturing variation.

The stripper sleeve 116 also has a tubular body that is slidably arranged around the outer core 114 to accommodate a relative movement therebetween, along the mold-stroke axis, whereby the slide pair 122 is openable (FIGS. 3B and 3C) and the closure 106 is strippable from the outer core 114 (FIGS. 3D and 3E). In this example, the stripper sleeve 116 does not define any portion of the molding cavity 101 (FIG. 1).

That being said, in other examples, not shown, the stripper sleeve 116 may have an alternative structure wherein it too defines a portion of the molding cavity in keeping with common practice in the art. Returning to the description of the present example, it can be seen that a top annular face on the tubular body of the stripper sleeve 116 defines a molded article engager 120 with which to engage the closure 106 to cause a stripping thereof from the outer core 114 with movement of the stripper sleeve 116 from a stripper sleeve molding position (FIG. 3A) towards a stripping position (FIG. 3E).

With further reference to FIG. 3B, it can be seen that the stripper sleeve 116 further defines a first opening cam 119A with which to engage, in use, a first opening cam follower 126A that is defined on a first slide 122A of the slide pair 122 to cause lateral opening movement thereof, relative to a second slide 122B of the slide pair 122, from a first slide molding position (FIG. 3A) towards a first slide clearance position (FIG. 3C), with an axial movement of the stripper sleeve 116 from the stripper sleeve molding position (FIG. 3A) towards the stripping position (FIG. 3E). Likewise, the stripper sleeve 116 also defines a second opening cam 119B (FIG. 3B) with which to engage, in use, a second opening cam follower 126B (FIG. 3B) that is defined on the second slide 122B to cause lateral opening movement thereof, relative to the first slide 122A, from a second slide molding position (FIG. 3A) towards a second slide clearance position (FIG. 3C), with movement of the stripper sleeve 116 from the stripper sleeve molding position (FIG. 3A) towards the stripping position (FIG. 3E).

The stripper sleeve 116 includes a first protuberance 118A that projects from a sidewall of the tubular body in between the first end thereof and a cylindrical guide portion 117. A first tapered face on the first protuberance 118A provides the first opening cam 119A. Likewise, the tubular body also defines a second protuberance 118B that projects from the sidewall of the tubular body in between the first end thereof and the cylindrical guide portion 117. The second tapered face on the second protuberance 118B provides the second opening cam 119B. The first protuberance 118A and the second protuberance 118B are located directly opposite each other across the tubular body.

That being said, in another non-limiting example, not shown, the first stack portion 110 may include some other number or arrangement of slides, or some other variety of split inserts, each with its own opening cam follower, wherein the number and placement of the corresponding opening cams on the stripper sleeve may correspond therewith. That being said, in another non-limiting example, not shown, the first opening cam 119A may have an alternative structure, such as a frusto-conical face that extends around the tubular body, that is able to cooperate with the opening cam follower of more than one slide such as with those of the first slide 122A and the second slide 122B.

The first slide 122A and the second slide 122B of the slide pair 122 are configured to define the encapsulated portion of a molding cavity 101 (FIG. 1) in cooperation with the inner core 112 and the outer core 114 when arranged in the first slide molding position and a second slide molding position, respectively. Both the first slide 122A and the second slide 122B are formed from a rectangular bar of material thus defining a bar body. The first slide 122A has a structure that mirrors that of the second slide 122B. Each slide 122A, 122B defines half of a pair of cylindrical passageways therethrough. Each of the cylindrical passageways defines a space through which the first stack portion 110 and a further first stack portion, not shown, are arrangeable. That is, the slide pair 122 (FIG. 1) are configured for use in a mold assembly 100 having a plurality of mold stacks, and wherein the slide pair 122 is structured to cooperate with a pair of the plurality of mold stacks. Of course, the particular number of mold stacks with which the slide pair 122 is co-operable is not particularly limited.

An upper portion of each of the cylindrical passageways defines the encapsulated portion of the molding cavity 101 (FIG. 1) in cooperation with outer core 114. Also shown, is a second opening cam follower 126B that is defined as an outwardly tapering groove that passes through a lower portion of each of the cylindrical passageways. The first opening cam follower 126A (FIG. 3B) is similarly defined on the first slide 122A.

The first mold shoe 170 broadly includes a first core retainer 154, a second core retainer 162, and a stripper retainer 168. The inner core 112 is coupled to the first core retainer 154, the outer core 114 is coupled to the second core retainer 162, and the stripper sleeve 116 is coupled to the stripper retainer 168. The first core retainer 154 includes a first core plate 150 with a first clamp plate 152 connected thereto between which is clamped a flange portion of the inner core 112. The second core retainer 162 includes a second core plate 158 with a second clamp plate 160 connected thereto between which is clamped a flange portion of the outer core 114. The stripper retainer 168 includes a stripper plate 164 with a third clamp plate 166 connected thereto between which is clamped a flange portion of the stripper sleeve 116.

The first mold shoe 170 also includes an ejector box 156. The ejector box 156 is coupled to the first core retainer 154 with a space 169 being defined therebetween within which the second core retainer 162 and the stripper retainer 168 are slidably arranged to accommodate repositioning thereof, in use, along the mold-stroke axis, and thereby reposition the outer core 114 and the stripper sleeve 116, respectively, relative to the inner core along the mold-stroke axis. Without limiting the means by which the second core retainer 162 and the stripper retainer 168 may repositioned along the mold-stroke axis, the repositioning may be provided by a two-stage actuator (not shown) that is linked with the ejector of the injection molding machine (not shown). The ejector box 156 further defines a passageway within which a guide bushing 167 is arranged, the guide bushing 167 being configured to guide movements of the stripper sleeve 116 in cooperation with a cylindrical guide portion 117 thereof.

The slide pair 122 is slidably linked with the ejector box 156 in a typical manner. In particular, the slide pair are slidably retained to the ejector box 156 by a pair of gibs (not shown) that are fastened to the ejector box 156 and that cooperate with a pair of guide flanges that are defined on opposite ends of each of the first slide 122A and the second slide 122B. In addition, a wear plate 155 separates the slide pair 122 from the ejector box 156.

The second mold half 104 broadly includes a second mold shoe 180 with which the second stack portion 130 is associated. More particularly, the second mold shoe 180 provides for coupling, in use, of the second stack portion 130 to a remaining one of the platens (not shown) of the injection molding machine (not shown).

The second mold shoe 180 includes a cavity plate 172 with a first retaining member 174A associated therewith. The cavity plate 172 is structured to have the second stack portion 130 mounted thereto, and the first retaining member 174A is arranged to be engagable with the first slide 122A on the first mold half 102 with the first mold half 102 and the second mold half 104 arranged in a mold-closed configuration, as shown, to retain the first slide 122A in the first slide molding position. The first retaining member 174A further defines a closing cam 175 with which to engage a closing cam follower on the first slide 122A with relative movement of the first mold half 102 and the second mold half 104 towards the mold-closed configuration.

Likewise, the second mold shoe 180 includes a second retaining member 174B associated therewith that is engagable, in use, with the second slide 122B on the first mold half 102 with the first mold half 102 and the second mold half 104 arranged in the mold-closed configuration, as shown, to retain the second slide 122B in the second slide molding position. The second retaining member 174B also defines a closing cam with which to engage a closing cam follower 124 on the second slide 122B with relative movement of the first mold half 102 and the second mold half 104 towards the mold-closed configuration.

In use, and as shown with reference to FIG. 3A, a typical injection molding cycle involving the mold assembly 100 begins with the mold assembly 100 being in the mold-closed configuration (i.e., closed and clamped).

Next, molding material is injected into the molding cavity 101, using known structure and steps, to form a closure 106. The closure 106 is then solidified, at least partially, in the molding cavity 101 with the application of in-mold cooling, using known structure and steps.

Next, as shown with reference to FIG. 3B, with the closure 106 having been cooled sufficiently to withstand opening of the mold assembly 100 and stripping from the first stack portion 110 without causing a defect therein (i.e. undesired plastic deformation), the mold assembly 100 is arranged into the mold-open configuration with relative separating movement of the first mold half 102 and the second mold half 104.

Next, as shown with reference to FIG. 3C, the first stack portion 110 is arranged for the first stage of ejection of the closure 106 thereon. This step involves moving the stripper sleeve 116 a first distance towards the stripping position, wherein the first opening cam 119A and the second opening cam 119B thereon engage the first opening cam follower 126A and the second opening cam follower 126B on the first slide 122A and the second slide 122B, to move them from the first and second slide molding positions (FIG. 3B) to the first and second slide clearance positions, respectively.

Next, as shown with reference to FIG. 3D, the first stack portion 110 is arranged for a third stage of ejection of the closure 106 thereon. This step involves moving the stripper sleeve 116 a further distance towards the stripping position with the molded article engager 120 thereon being in contact with a bottom surface of the closure 106. During this stage, the outer core 114 is moved in tandem with the stripper sleeve 116, wherein the outer core 114 is moved relative to the inner core 112 to release the part (e.g., plug seal) of the molded article (e.g., closure) that was encapsulated therebetween.

Lastly, as shown with reference to FIG. 3E, the first stack portion 110 is arranged for a final stage of ejection of the closure 106 thereon. This step involves moving the stripper sleeve 116 a final distance to the stripping position, with the outer core 114 held stationary, whereby the closure 106 is stripped from contact with the outer core 114, by virtue of being pushed therefrom through engagement with the molded article engager 120 on the stripper sleeve 116.

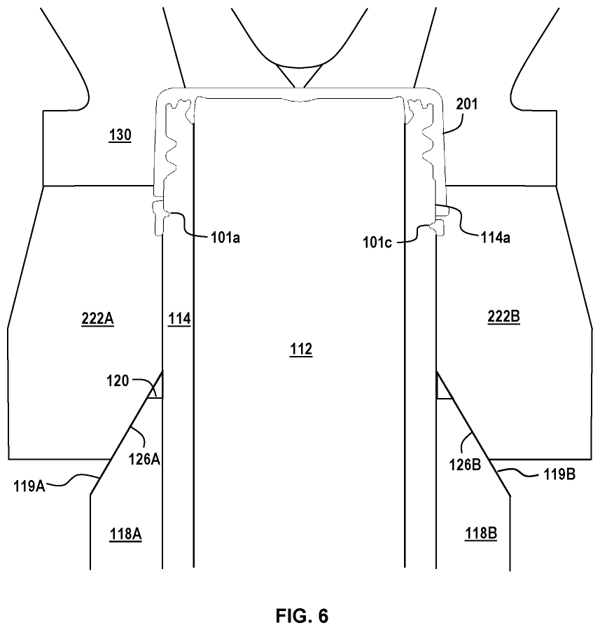

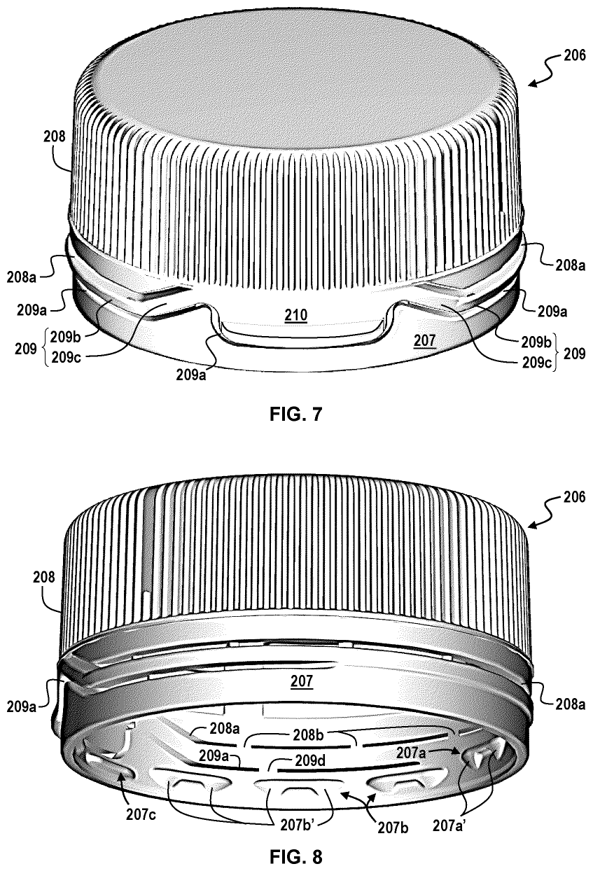

Turning now to FIG. 6, there is shown an enlarged view similar to that of FIG. 2, but showing the mold assembly 100 in a second, tethered configuration. The only difference between this, second configuration and the first configuration is that the slides 122A, 122B have been replaced with different slides 222A, 222B. In this configuration, the core 112, 114 and slides 222A, 222B together describe a cavity 201 for molding a tethered closure 206, shown more clearly in FIGS. 7 and 8. Similar features of this, tethered closure 206 are labelled with similar numbers to those of the non-tethered closure 106, but these are incremented by 100.

This, tethered closure 206 has a tamper evidence band 207 that is frangibly connected to, but only partially separable from, a lid 208 of the closure 206. More particularly, the closure 206 includes a pair of tethers 209 that join the tamper evidence band 207 to the closure lid 208 and a tongue 210 depending from the lid 208 between the tethers 209. As in the non-tethered closure 106, the tamper evidence band 207 of this, tethered closure 206 is frangibly connected to the lid 208 along a first line of weakness 208a.

However, the tethered closure 206 also includes a second line of weakness 209a, along part of the circumference of the tamper evidence band 207. The tethers 209 are described between the first and second lines of weakness 208a, 209a, and include a circumferential portion 209b and a sloped portion 209c in this example, which extends from the circumferential portion 209b to the lid 208. The second line of weakness 209a also describes the tongue 210, which is located between the sloped portions 209c. Other configurations are also possible, for example in which one or both of the tongue 210 and/or the sloped portion 209c of the tethers 209 is omitted. The skilled person will also appreciate that other features may be varied, for example the two tethers 209 may be replaced with a single tether and/or their connection locations may be modified.

In this example and as can be seen from FIG. 8, the second line of weakness 209a, and therefore the tethers 209, extend about more than half of the circumference of the closure 206. As a result, part of the second line of weakness 209a is described by each of the slides 222A, 222B, such that both slides must be replaced when reconfiguring the mold assembly 100 between the first and second configurations. However, it is also envisaged that these features extend about only half or less than half of the circumference of the closure 206, such that all tether describing features are incorporated in a single slide 222B. In such cases, reconfiguration of the mold assembly 100 would only require the replacement of a single non-tethered slide 122B with a tethered slide 222B.

The skilled person will appreciate that, as with the non-tethered closure 106, the lines of weakness 208a, 209a incorporate frangible connections, which may be achieved by any known arrangement. In the arrangement shown in FIGS. 7 and 8, the frangible connection includes thin bridges 208b, 209d joining the tamper evidence band 207 to the lid 208, which are designed to sever when the lid 208 is unscrewed from the container neck, whilst the tamper evidence band 207 is retained thereon by virtue of the cams 207a, 207b, 207c engaging a flange on the neck (not shown).

As illustrated in FIG. 8, the differing positions of the three sets of cams 207a, 207b, 207c is necessitated by the second line of weakness 209a. More specifically, the first group of cams 107a is located immediately below the first line of weakness 208a, while the second group of cams 207b is located immediately below the portion of the second line of weakness 209a that describes the circumferential portion 209b of the tethers 209. The third group of cams 207c is located immediately below the portion of the second line of weakness 209a that describes the tongue 210.

As explained above, the skewing of the cams 207a, 207b, 207c results in some deformation of the tamper evidence band 207 as the lid 208 of the closure 206 is removed from the container neck (not shown), which can be advantageous. As such, this unforeseen advantage of skewing the cams 207a, 207b, 207c combined with the simpler means of reconfiguring the mold assembly 100 simply by replacing one or both slides provides a novel, synergistic reconfigurable mold assembly.

It will be appreciated that the configuration of the elements of the mold assembly 100 may vary, particularly although not exclusively as described above. It will also be appreciated by those skilled in the art that several variations to the construction and/or use of aforementioned examples are envisaged without departing from the scope of the invention. It will also be appreciated by those skilled in the art that any number of combinations of the aforementioned features and/or those shown in the appended drawings provide clear advantages over the prior art and are therefore within the scope of the invention described herein.

1. A mold assembly for molding tethered and non-tethered closures, the assembly comprising:
a core describing an inner portion of a closure, the core including first and second recess portions in its circumferential surface which describe respective first and second radial projecting portions of a tamper evidence band of the closure for engaging a flange of a neck of a container to which the closure is to be installed; and
a plurality of slides describing respective outer closure portions; the assembly comprising:
a first, non-tethered configuration, in which the core and a first combination of the slides together describe the closure having the tamper evidence band, which is frangibly connected to and completely separable from a lid of the closure; and
a second, tethered configuration, in which the core and a second combination of the slides together describe the closure having the tamper evidence band, which is frangibly connected to and partially separable from a lid of the closure, and one or more tethers that join the tamper evidence band to the closure lid;
wherein the first and second recess portions of the core are at different axial locations for accommodating the one or more tethers in the second configuration.

2. The mold assembly according to claim 1, wherein the core comprises an end portion describing an inner surface of a top wall of the closure lid and the second recess portion is spaced further from the end portion than the first recess portion.

3. The mold assembly according to claim 2, wherein the slides describe a first line of weakness between the tamper evidence band and the closure lid at a first axial position in both the first and second configurations, and the slides describe at least part of the or each tether between the first line of weakness and the second recess portion in the second configuration.

4. The mold according to claim 2, wherein the core comprises a third recess portion in its circumferential surface which describes a third radial projecting portion of the tamper evidence band of the closure for engaging the flange of the neck of a container to which the closure is to be installed, the third recess portion being spaced further from the end portion than the first and second recess portions.

5. The mold according to claim 4, wherein the one or more tethers comprise a pair of tethers and a tongue depends from the closure lid between the pair of tethers.

6. The mold according to claim 1, wherein the plurality of slides comprises first, second and third slides, the first combination of slides comprising the first and second slides and the second combination of slides comprising the first and third slides.

7. The mold according to claim 6, wherein the first and second slides have substantially the same or a mirrored shape and configuration, such that a outer surface of the closure described by the slides in the first, non-tethered configuration is symmetrical.

8. The mold according to claim 6, wherein the one or more tethers are described by the third slide in the second, tethered configuration.

9. The mold according to any claim 1, wherein the plurality of slides comprises first, second, third and fourth slides, the first combination of slides comprising the first and second slides and the second combination of slides comprising the third and fourth slides.

10. The mold according to claim 1, wherein the first and second recess portions comprise separate first and second recesses respectively, each recess describing a respective cam projecting radially inwardly from the tamper evidence band.

11. The mold according to claim 10, wherein at least one of the first and second recess-portions is sloped on an opposite side to the closure lid, so as to describe a lead-in ramp on the respective cam described thereby.

12. A method of reconfiguring a mold assembly for making closures between a first configuration for making non-tethered closures and a second configuration for making tethered closures, the method comprising replacing one or more slides without replacing a core of the mold assembly, such that the non-tethered closure and the tethered closure both have a tamper evidence band with radial projecting portions at different axial locations.

13. The method according to claim 12, wherein only one slide is replaced such that tethers are confined to one side of the tethered closure.

14. A closure comprising a lid and a tamper evidence band frangibly connected to and completely separable from the lid, wherein the tamper evidence band comprises first and second radial projecting portions at different axial locations for engaging a flange of a neck of a container to which the closure is to be installed.

15. The closure according to claim 14, wherein the tamper evidence band comprises a third radial projecting portion at a different axial location that the first and second radial projecting portions.
